(19) United States
(12) Patent Application Publication
(10) Pub. No.: US 2003/0105700 A1
(43) Pub. Date: Jun. 5, 2003

(54) Method and apparatus for establishing and administering a wealth transfer plan

(75) Inventors: Michael D. Brown, Irvine, CA (US); Jonathan G. Blattmachr, Garden City, NY (US)

Correspondence Address: Bernard L. Kleinke, Foley & Lardner, 23rd Floor, 402 West Broadway, San Diego, CA, 92101-3542, US

(73) Assignee: Spectrum Group Investments, LLC

(21) Appl. No.: 10/043,989

(22) Filed: Jan. 9, 2002

Related U.S. Application Data
(60) Provisional application No. 60/337,758, filed on Dec. 3, 2001.

(51) Int. Cl. G06F 17/60

(52) U.S. Cl. 705/36; 705/38

(57) ABSTRACT

A system and method for the efficient transfer of wealth is disclosed. The system comprises a transferor having wealth and a transferee intended to be the recipient of transferred wealth. The transferee may be a trust. An insurance policy purchased by the transferee is subject to a split-dollar agreement by which the death benefit of the policy is assigned to a the transferor in exchange for payment of at least the death-benefit portion of the premiums. When sufficient premiums have been paid to effectuate the policy for the life of the insured, the split-dollar agreement may be canceled, reverting full ownership in the policy to the transferee.

### RELATED APPLICATION

The present application claims priority under 35 U.S.C. §119(e) to U.S. Provisional Patent Application Serial No. 60/337,758, filed Dec. 3, 2001, which is hereby incorporated by reference in its entirety.

### FIELD OF THE INVENTION

The present invention relates in general to a method and apparatus for implementing and administering a wealth transfer plan. It more particularly relates to a method and apparatus for implementing and administering such a plan, which utilizes life insurance to transfer a policy to another entity, such as a generation skipping trust in an effective manner.

### BACKGROUND ART

There have been many different types and kind of systems for implementing financial plans. For example, reference may be made to the following U.S. Pat. Nos. 3,634,669; 4,648,037; 5,191,522; 5,214,579; 5,231,571; 5,233,514; 5,429,506; 5,631,828; 5,761,441; 5,819,230; 5,933,815; 5,966,693; 5,999,917; 6,018,714; 6,064,969; 6,161,096.

Many of these financial plans relate to mortgages and insurance plans. However, they are not specifically related to the transfer of wealth from one person to another.

It has been found to be desirable to effectively transfer wealth to others, such as grandchildren or other family members in a cost-effective manner. There have been various estate planning techniques employed in the past. For example, generation-skipping trusts have been employed to be an effective tool in conveying one's wealth to members of one's family.

There can be undesirable costs incurred in connection with the funding of such a trust. Such costs can include the cost of liquidating assets at an undesirable time to fund the transfer. This is especially undesirable where very large sums of money or assets are to be transferred. Also, the funding of the trust can cause the unwanted imposition of taxes such as estate taxes or gift taxes which could otherwise diminish the effective amount of the funding. An outright transfer to another, such as a family member, can also, of course, trigger estate or gift taxes which would likewise diminish the amount of the transfer of wealth.

Thus, the disclosed embodiment of the present invention helps in the effective transfer of wealth, while minimizing or reducing the costs associated with the transfer.

### DESCRIPTION OF THE DRAWINGS

FIG. 1 is a block diagram of a system according to one embodiment of the invention for implementing and administering the wealth transfer plan illustrated in FIG. 1;

FIG. 2 illustrates the state of the system of FIG. 1 at termination of the split-dollar agreement; and

FIG. 3 illustrates the state of the system of FIG. 1 if the insured dies after termination of the split-dollar agreement.

### DETAILED DESCRIPTION OF PREFERRED EMBODIMENTS

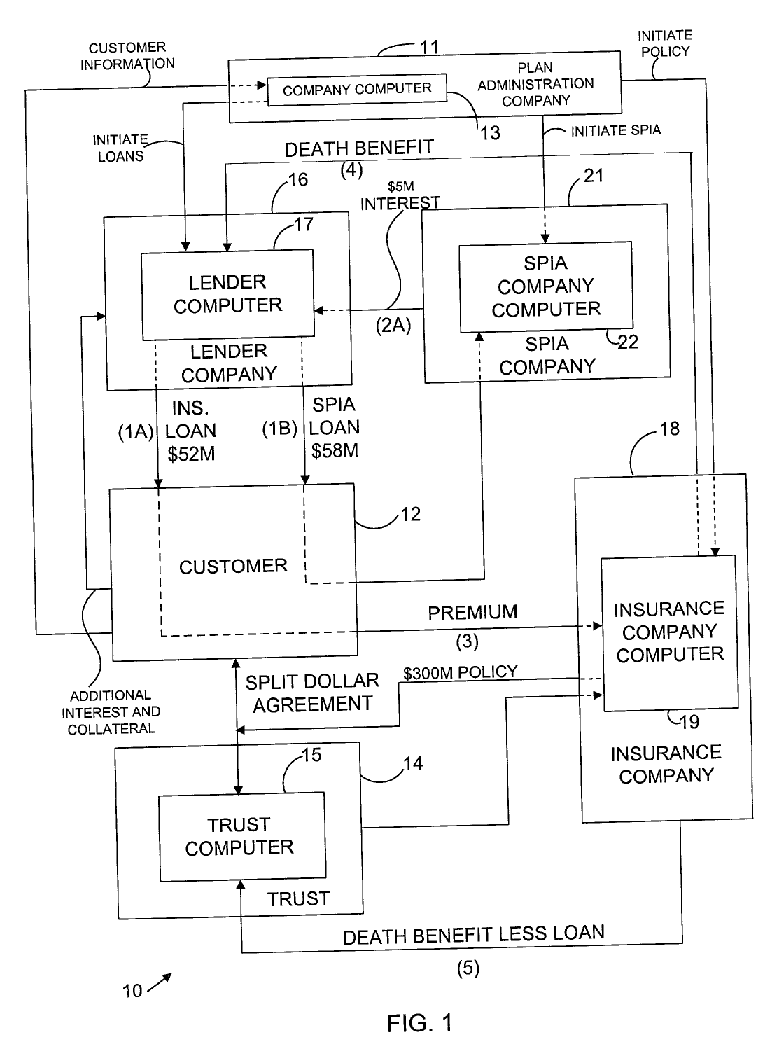

Referring now to the drawings, and more particularly to FIG. 1, there is shown a system 10 for establishing and administering a wealth transfer plan in accordance with a preferred embodiment of the present invention under the control of a plan administration company 11 employing a computer 13. The system 10 is used to transfer wealth from a customer 12 to a recipient such as a generation skipping trust 14 which may be created for a beneficiary and which may have a recipient trust computer 15. The customer may be an individual or another entity. Similarly, the recipient or the beneficiary of the trust may be one or more individuals or another entity.

The plan administration company initially gathers customer information from the customer. This information may be demographic and financial information which may be entered into the company computer 13 to facilitate establishment and subsequent administration of the plan. In this regard, the company computer 13 may directly receive a message from the customer 12 including the desired information.

The plan includes the purchasing an insurance policy from an insurance company 18 having an insurance company computer 19. The purchase of the policy may be initiated by the plan administration company 11 by transmitting a message from the company computer 13 to the insurance company computer 19. The policy may be a universal life insurance or a variable universal life insurance policy on the life of an insured individual. The policy may have a substantial death benefit, often in excess of $150 million.

The plan administration company 11 causes the trust 14 to initially apply for the policy, making the trust the owner of the policy. In this regard, a message may be sent directly from the company computer 13 to the trust computer 15 or the message may be relayed by the insurance company computer 19. The trust 14 may obtain funds for the initial premium either as a taxable transfer from the customer 12 or in the form of a loan from the customer 12. The initial premium is preferably a small payment only to secure the policy. For example, the initial premium may be a quarterly premium.

Once the policy has been secured, the plan administration company 11 causes the customer 12 and the trust 14 to enter into an endorsement split-dollar agreement. In this regard, the company computer 13 may send messages to the customer 12 and the trust 14. This split dollar agreement functions differently than conventional private split dollar agreements. Conventional private split dollar agreements, known as private reserve split dollar arrangements, require the insured to own the cash value and the generation-skipping trust for the recipient being entitled to the death benefit. See Internal Revenue Service Private Letter Ruling 9636033. By contrast, the split dollar agreement used in the present plan is called an endorsement split dollar agreement. The Internal Revenue Service (IRS) has ruled that both versions, endorsement and/or collateral assignment, have the same tax result. Thus, the cash value is owned by the trust 14 and the death benefit is assigned to the grantor of the trust, or the customer 12, for the period of the split dollar agreement.

The customer 12 may pay for the value of the death benefit received, which payment is essentially “rent” in view of the fact that the customer 12 does not own any equity in the policy. In this regard, a message may be transmitted from the customer to the insurance company with a fund transfer, for example. The payment required for the annual “rental” of the death benefit is referred to as the “economic benefit” by the IRS. To ensure that taxpayers pay the appropriate amount for this death benefit, the IRS has published a table, Table PS58, to value the term insurance portion of a policy. The IRS issued a notice (Notice 2001-10) stating that in future years different tables may be used to measure the “economic benefit” of a policy used in conjunction with a split dollar agreement, such as the one used in this plan.

Thus, the plan administration company 11 may cause the customer 12 to make premium payments to the insurance company 18 via, for example, fund transfers to the insurance company computer 19. The amount of the premiums actually paid by the customer 12 preferably comport with the economic benefit published in Table PS58. The amount, however, is generally greater than the actual term cost of the policy. The excess premium is directed to the cash value component of the policy.

In another embodiment of the invention, the customer 12 may pay for the premiums by obtaining a loan from a lender company 16 having a lender computer 17. In this regard, the company computer 13 may transmit a message to the lender computer 17 requesting the loan, and the lender computer 17 may then transmit a message with a fund transfer to the customer. In a further embodiment of the invention, the plan administration company 11 may cause the customer 12 to also borrow sufficient money from the lender company 16 to purchase a single purchase immediately annuity (SPIA), as initiated by the plan administration company 11, from an SPIA company 21 having an SPIA company computer 22. The SPIA purchase may be accomplished by the company computer 13 via a message transmitted to the SPIA company computer 22. Payments to the SPIA company may be made by the customer by transmitting messages to the SPIA company computer 22. The SPIA generates periodic income to pay at least a portion of the interest on the interest-only loan to the lender company 16 by transmitting payments to the lender computer 16 or via other forms of payment.

As indicated in FIG. 1, as an example, the lender company 16 may provide an interest-only loan of $52 million dollars to the customer 12, which in turn provides the $52 million as the premium for the large death benefit of $300 million for the policy. This type of policy may require only a single, one-time premium payment to pay up the policy, or the premium may be paid periodically over time, such as one-third of $52 million for each year over a three year period. This type of insurance policy may, for example, have a declining death benefit. For example, after ten years, the death benefit may be $150 million.

After a certain period of time such as four or five years, the customer 12 may have transferred enough money in the form of “rent” payments that the policy may remain in force through the grantor's life. At this point, the split-dollar agreement may be terminated. In this regard, the company computer 13 may transmit a message to both the customer 12 and the trust computer 15 instructing them to terminate the agreement. Thus, the customer 12 may no longer be entitled to the death benefit, and the customer 12 may have no ownership rights in the policy. Therefore, the policy may revert to the initial owner, the trust 14, in its entirety. Therefore, after a certain period of time, such as about six years, of renting the death benefit, a paid-off policy with a substantial cash value may then be owned by the trust. No gift tax or income tax return may have been filed, and no gift tax or estate tax may have been generated.

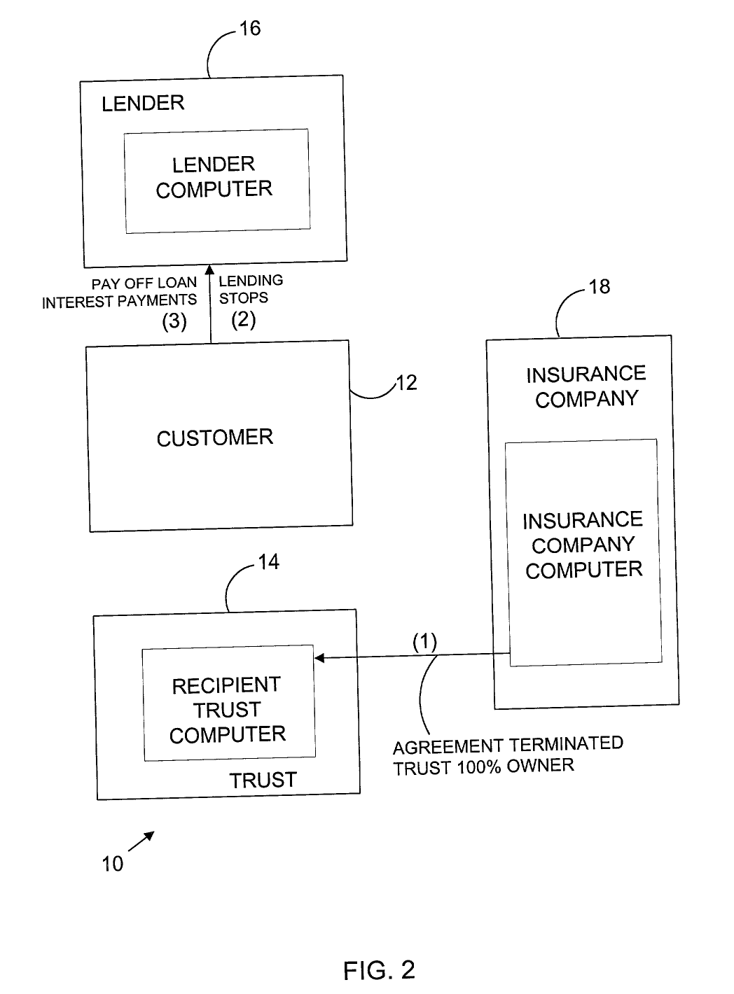

As shown in FIG. 2, at termination of the split-dollar agreement, the customer 12 no longer owns a portion of the insurance policy, and the trust 14 then owns 100% of the policy. The lender company 16 ceases making loans to the customer 12, and the customer's term cost payment ceases. The customer 12 may have two options. The customer 12 may then pay off the loan from existing funds, or may continue to make interest payments to the lender company 16.

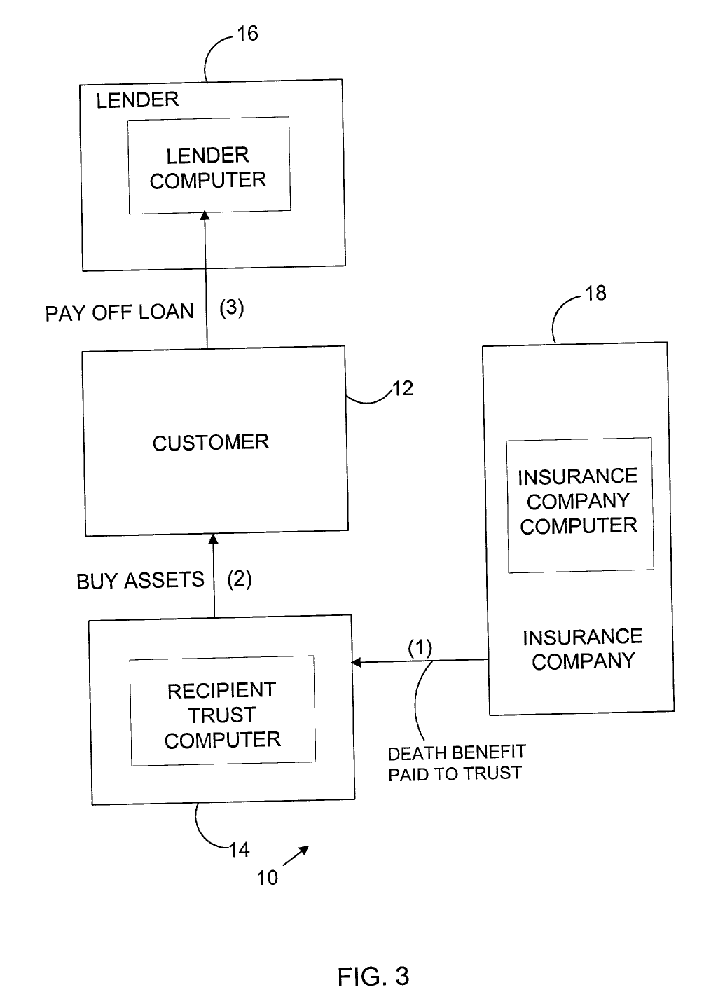

Referring now to FIG. 3, should the customer 12 die after the termination of the split dollar agreement, death benefit proceeds (owned 100% by the trust) may then be paid estate-tax-free to the trust 14. The trust 14 receives the death benefit proceeds and may buy assets from the estate of the customer 12. The estate of the customer 12 may then pay off the loans to the lender company 16 with the proceeds from the sale of assets.

In another embodiment, after the termination of the split-dollar agreement, the trust 14 may cancel the policy, thereby benefiting from the distribution of the cash value in the policy.

If the customer should die during the term of the split-dollar agreement, the death benefit may be paid to his or her estate and taxed accordingly. Although an early death may create a financial windfall that may be income tax free, insurance proceeds would be subject to any estate tax that is due.

Thus, the system 10 according to one embodiment of the invention provides for the establishment and administration of a wealth transfer plan. The plan at its core may involve a life insurance policy and a split-dollar agreement. Additional enhancements may include borrowing funds to finance premiums and a single premium immediate annuity (SPIA) to pay some or all of the interest on the loan. The combined strategy, with all three components, the life insurance policy, the non-callable loan and the SPIA may produce wealth transfer results at a substantial cost savings such as gift tax savings.

The end result of the use of a system according to the invention may be that the customer is allowed to pay relatively large payments such as about $6 to $10 Million per year to the insurance company in return for the enjoyment of $100 to $150 million death benefit. One benefit of this strategy may be that, if the customer is of good health, the actual cost of the underlying insurance may be far less than the “economic benefit” prescribed by the IRS. Thus, the spread between the actual cost of insurance and the fair value measure (Economic Benefit) used by the IRS may enable for property to be transferred to the trust with little or no transfer tax by utilizing the plan of the disclosed embodiment of the present invention.

Such a plan may be relatively easy to implement if the customer had a large sum of money such as, for example, about $30 to $40 Million of liquid assets for which he or she may have no set purpose. Since most people are not in such a position, according to the disclosed embodiments of the present invention, a premium financing company or lender may advance the premiums to the customer. Such loans may be based on one-year LIBOR plus a margin of approximately 1.25%. This type of long-term financing may allow the grantor to borrow the money, and may pay interest only during his or her life for a non-callable loan. At the death of the customer, assuming it is after the termination of the split-dollar agreement, the death benefit may then be paid to the trust. The trust may then buy assets from the customer's estate for the amount of the loan. The assets may then be transferred to the trust as part of the sale, and the death benefit proceeds are transferred to the customer's estate to retire the loan. For example, if the final debt to the lender is about $40 million, then about $40 million of death benefit proceeds may then be used to buy assets from the customer's estate. The estate may then take the $40 million of death benefit proceeds and may use it to retire the loan. There may be no tax on this transaction, and the assets may be sold to the trust to receive a step-up in basis at death. This may allow the debt to be in the customer's estate, while the death benefit may be paid to the trust.

The customer may simply pay interest-only for life and may receive the benefits of the strategy. However, the interest cost could be, for example, as much as $1.5 to $2 million a year. In order to reduce this cost, the lender may finance a portion of the interest, and may loan an additional amount to the customer to purchase a Single Premium Immediately Annuity (SPIA) which may be issued by insurance companies and may pay a monthly or annual amount to the grantor for his or her life. At his death, the annuity company may retain the balance of the premiums, if any. Because of this feature, the SPIA payment may be, for example, annually about 15% of the amount paid in premium. Thus, if the loan for the insurance was, for example, $30 Million and an additional $15 million was transferred to the SPIA for a $45 million total loan at 6%, it may carry an interest cost of about $2.7 million per year. The SPIA payment on $15 million may be about $2.25 million per year leaving a difference of about $450,000. At the customer's death, $45 Million of death benefit may be used to purchase assets from the customer's estate and may retire the debt. This funding of the SPIA may reduce the net benefit of the strategy by approximately 50% of the SPIA loan (in this case, $7.5 million if a $15 million SPIA was purchased) but may drastically reduce the lifetime cost of the strategy. The cost may decrease from $1.8 million per year for a benefit of $70 million to $400,000 for a benefit of $63 million. Additional SPIA may be purchased, if desired, to get the net cost almost to zero. The SPIA Company may be a highly-rated company that is approved by the lender.

In summary, the leveraged private split-dollar strategy of the plan employing an SPIA enables the customer 12 to borrow money, and use a portion to buy life insurance and a portion to buy an SPIA. In one example, approximately ⅔ of the borrowed money may be used to buy a life insurance policy and approximately ⅓ is used to buy an SPIA. The SPIA pays most or all of the interest due on the loan, and the death benefit of the policy repays most or all of the principal of the loan. The net result of the strategy is that, for example, $70 to $80 million is transferred to the generation-skipping trust 14 after most or all the taxes have been paid, and most or all of the loans have been retired. In order to achieve a similar rate of benefit, assuming, for example, a 45% income tax rate and a 50% estate tax rate, the customer 12 may have to earn approximately 48% total return compounded annually and live past life expectancy in order to receive similar benefits as the strategy provided by the plan.

While the above mentioned strategy may enable the customer 12 to buy a large amount of insurance with borrowed money and efficiently use an SPIA to pay the interest, he or she may not transfer any assets during his or her life. Another variation on the split dollar strategy of the plan involves the lifetime transfer from the customers estate. This variation is called a reimbursement split dollar arrangement because the customer reimburses the life insurance trust for the economic benefit (that is, the term insurance benefit) that he or she receives other loss paying premiums directly to the insurance company.

In this arrangement, the trust that buys the policy may enter the same split-dollar agreement, and that may provide the customer with the term element of the policy. With the trust making payments to the insurance company, the customer may reimburse the trust with a large amount of assets and some cash. The amount of cash that he or she may transfer may still be loaned by the lender company and an annuity may still purchased to pay the interest. This cash payment may be given to the insurance companies to provide the death benefit. This cash payment is much less than the payment under the above-noted option (there only needs to be sufficient premium paid to the insurance company to keep the death benefit in force for the split dollar period). The balance of the reimbursement may be made with assets, presumably at a discount, so that the customer may transfer, for example, $50, $80 or even $100 million of assets with an appropriate discount to the trust.

This variation of the split dollar is called a reimbursement split dollar because the customer may reimburse the trust using assets. The reimbursement split dollar with a note may be designed to pay back the note principal and interest through economic benefit of term insurance, or to pay interest only through economic benefit of the term insurance.

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented.

What is claimed is:

1. A method of transferring wealth, comprising:
causing a transferee to purchase an insurance policy from an insurance seller on the life of an insured individual, said policy comprising a cash value and a term benefit;
dividing ownership of said policy between said transferee and a transferor, wherein said transferee owns said cash value and said transferor owns said death benefit in said divided ownership;
causing said transferor to transfer wealth as premiums for at least said death benefit; and
unifying ownership of said policy with said transferee.

2. The method according to claim 1, further comprising:
causing said transferor to borrow a first loan from a lender, said first loan being sufficient to match said premiums for at least said death benefit.

3. The method according to claim 1, further comprising:
causing said transferor to borrow a second loan from a lender, said second loan being sufficient to purchase an annuity, said annuity providing an annual benefit.

4. The method according to claim 1, wherein dividing is pursuant to a split-dollar agreement.

5. The method according to claim 4, wherein said unifying is pursuant to cancellation of said split-dollar agreement.

6. The method according to claim 1, wherein said transferee is a trust.

7. A system of transferring wealth, comprising:
means for causing a transferee to purchase an insurance policy from an insurance seller on the life of an insured individual, said policy comprising a cash value and a term benefit;
means for dividing ownership of said policy between said transferee and a transferor, wherein said transferee owns said cash value and said transferor owns said death benefit in said divided ownership;
means for causing said transferor to transfer wealth as premiums for at least said death benefit; and
means for unifying ownership of said policy with said transferee.

8. The system according to claim 7, further comprising:
means for causing said transferor to borrow a first loan from a lender, said first loan being sufficient to match said premiums for at least said death benefit.

9. The system according to claim 7, further comprising:
means for causing said transferor to borrow a second loan from a lender, said second loan being sufficient to purchase an annuity, said annuity providing an annual benefit.

10. The system according to claim 7, wherein means for dividing is a split-dollar agreement.

11. The system according to claim 10, wherein said means for unifying is a cancellation of said split-dollar agreement.

12. The system according to claim 7, wherein said transferee is a trust.

13. A program product, comprising machine readable program code for causing a machine to perform the following method steps:
causing a transferee to purchase an insurance policy from an insurance seller on the life of an insured individual, said policy comprising a cash value and a term benefit;
dividing ownership of said policy between said transferee and a transferor, wherein said transferee owns said cash value and said transferor owns said death benefit in said divided ownership;
causing said transferor to transfer wealth as premiums for at least said death benefit; and
unifying ownership of said policy with said transferee.
